(19) United States
(12) Patent Application Publication
(10) Pub. No.: US 2026/0296037 A1
(43) Pub. Date: Oct. 1, 2026

(54) METHOD AND SYSTEM FOR ADDRESSING INK BATCH VARABILITY IN INKJET PRINTING

(71) Applicant: Xerox Corporation, Norwalk, CT (US)

(72) Inventors: James E. Baxter, Canandaigua, NY (US); Seemit Praharaj, Marlborough, NH (US); Christine A. Steurrys, Williamson, NY (US); Jason Matthew Lefevre, Penfield, NY (US); Thomas J. Wyble, Williamson, NY (US); Christine A. Keenan, Fairport, NY (US)

(21) Appl. No.: 19/091,487

(22) Filed: Mar. 26, 2025

(51) Int. Cl. B41J 2/175; B41J 2/045; B41J 2/165; B41J 2/195; B41J 11/00; B41J 29/00; G06K 7/14

(52) U.S. Cl. CPC B41J 2/17546; B41J 2/04581; B41J 2/04588; B41J 2/04596; B41J 2/04598; B41J 2/1652; B41J 2/195; B41J 11/0085; B41J 29/00; B41J 2002/16573; G06K 7/1417

(57) ABSTRACT

To mitigate the effects of ink lot variability in a print system, a controller will identify when an ink container is being replaced, identify a code that is associated with an ink batch from which the ink in the container was sourced, and cause the print engine of the print system to execute a prefire operation using one or more prefire settings that are associated with the ink batch. For example, the prefire operation may include applying electrical pulses to the printhead that perturb the nozzles of the printhead to vibrate ink menisci and/or agitate ink in the printhead. After the prefire operation, the print system will then return to a normal document printing operation.

### BACKGROUND

Inkjet printers use printheads that have an arrangement of nozzles that eject ink onto a substrate. An inkjet printer forms an image by selectively ejecting ink drops from the printhead nozzles, also referred to as jets or inkjets, onto an image receiving surface. In a direct inkjet printer, the printheads eject ink drops directly onto the surface of a print medium such as a paper sheet or a continuous paper web. In an indirect inkjet printer, the printheads eject ink drops onto the surface of an intermediate image receiving member such as a rotating imaging drum or belt.

During printing, the printheads and the image receiving surface move relative to one other, and the inkjets eject ink drops at appropriate times to form an ink image on the image receiving surface. A controller in the printer generates electrical signals, also known as firing signals, at predetermined times to activate individual inkjets in the printer.

The ink ejected from the inkjets can be liquid ink that is stored in containers installed in the printer. Alternatively, some inkjet printers use phase change inks that are loaded in a solid form and delivered to a melting device that heats and melts the solid phase change ink to a liquid form that is supplied to a printhead for printing as liquid drops onto the image receiving surface.

In the field of inkjet printing, even minor deviations in ink formulation and/or small levels of contaminants in an ink batch can cause substantial variations in printer performance between ink batches. Minor inconsistencies in ink composition can cause the ink to dry or coagulate within the printhead nozzles. This leads to unacceptable print quality, as even a partial clog in a printhead nozzle can cause the ink to be ejected from the nozzle at an angle that is other than the desired straight line.

While many printers have a purge operation available in which ink can be purged through the printheads to help remove contaminants, the purge process is not always effective when the ink itself is causing the issue, such as if one or more components of the ink fall out of solution and adhere to the ink delivery hardware in the printhead. Instead, ink composition variability can lead to light or dark streaks in images printed by the printhead. In some instances, it can lead to other consequences, all of which require maintenance and/or replacement of the printhead.

This document describes improvements that address at least some of the issues described above.

### SUMMARY

Some aspects described in this document describe a print system that includes: (a) an ink supply system comprising an ink reservoir configured to receive ink from an ink container and hold the ink for use in a printing operation; (b) a printhead that is fluidly connected to the ink supply system to receive the ink from the ink supply system; and (c) a control system comprising a processor and programming instructions. The programming instructions are configured to cause the processor to, in response to receiving a code that is associated with the ink container: process the code to identify an ink batch from which the ink that the ink supply system receives from the container was sourced; identify one or more prefire settings that are associated with the ink batch; and cause the printhead to execute a prefire operation according to the one or more prefire settings.

Some aspects described in this document include a method of addressing variations in ink batches. The method may be implemented in a print device that comprises an ink supply system, a printhead that is fluidly connected to the ink supply system, and a control system comprising a processor. In response to receiving a code that is associated with an ink container that is installed in the ink supply system, the control system may (i) process the code to identify an ink batch from which the ink that the ink supply system receives from the container was sourced, (ii) identify one or more prefire settings that are associated with the ink batch, and (iii) cause the printhead to execute a prefire operation according to the one or more prefire settings.

### BRIEF DESCRIPTION OF THE DRAWINGS

FIG. 1 is a block diagram that depicts elements of a prior art marking system, such as one that may appear in the prior art.

FIG. 2 depicts example elements of a printhead.

FIG. 3 is a block diagram of a substrate passing under printhead assemblies in a CMYK print system.

FIG. 4A illustrates an example test pattern printed by a printhead assembly that is not experiencing an ink drop directionality problem, while FIG. 4B illustrates an example test pattern printed by a printhead assembly that is experiencing issues that could be caused by different ink batches in the different heads of the assembly.

FIG. 5 is a flowchart illustrating steps that may be included in a method of addressing ink batch variability in inject printing.

FIG. 6 illustrates a process of receiving information from a barcode or transmitter of an ink container.

### DETAILED DESCRIPTION

In the various embodiments, the devices, methods and systems of the present disclosure relate to marking systems of printers that include printheads. Specifically, the present disclosure relates to printheads and ink delivery systems, and methods of operating such systems to address drop directionality degradation caused by minor ink composition differences, such as those that may result from small levels of contaminants in particular batches of ink, across various batches of ink used by the systems.

As discussed in this document, the term marking system refers to the elements of a printer that deliver inks to a substrate, including the printhead(s) and components that deliver ink to the printhead(s). A printer may include an outer housing that stores the marking system and includes a user interface which allows a user to interact with the system. Color printers typically have multiple printheads. As housings and user interfaces of printers are well known, the present disclosure mainly focuses on marking systems and improvements thereof.

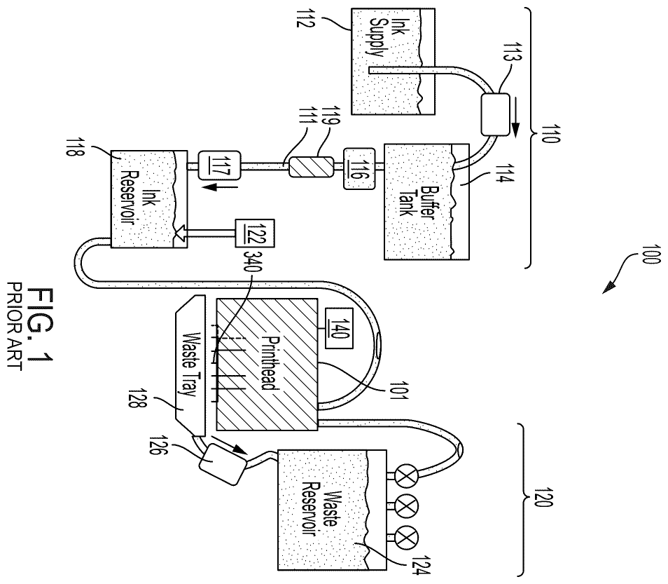

Referring to FIG. 1, elements of a print engine of a prior art marking system 100 are depicted. The marking system includes a printhead 101, an ink supply system 110, and a waste system 120. The printhead 101 includes hundreds, and in some cases, thousands of small nozzles that are responsible for ejecting ink and creating images on the surface of a medium. The ink supply system 110 provides ink from one or more ink sources to the printhead 101. The waste system 120 manages and removes excess ink, debris and contaminants from the printhead 101.

The marking system 100 also includes a control system 140. The control system 140 includes one or more microcontrollers or processors with embedded software and/or a memory containing programming instructions that is configured to enable the control system 140 to control the operations of the marking system 100 and its components, including printhead 101. As shown, the control system 140 is illustrated as being located onboard the marking system 100, and in particular as being a controller that is focused control of the printhead 101. However, in some configurations, the control system 140 also may include one or more processors, memory devices, and programming instructions that are located elsewhere in the marking system 100 and/or offboard the marking system 100, and that are in systems that are communicatively connected to the print engine of the marking system 100 via one or more communication paths.

The ink supply system 110 includes an ink supply 112, a buffer tank 114, a filter 116 and degasser 119, and an ink reservoir 118. The ink supply system 110 additionally includes a first ink supply pump 113 and a second ink supply pump 117. The first ink supply pump 113 is positioned in a conduit between the ink supply 112 and buffer tank 114, and during operation it is configured to draw and transport ink from the ink supply 112 to the buffer tank 114. The second ink supply pump 117 is positioned in a conduit 111 between buffer tank 114 and the ink reservoir 118, and it is positioned to draw and transport ink from the buffer tank 114, through the filter 116 and degasser 119, to the ink reservoir 118.

In some configurations, the buffer tank 114 is the main ink source during use of the marking system 100. It holds ink that is available for immediate use by the printhead 101. In some embodiments, the buffer tank 114 includes separate containers which hold different ink colors. Similarly, multiple ink supplies 112 of different colors may be provided, and multiple ink reservoir 118 compartments may be included. To simplify the system, a single conduit and a single pump are depicted as fluidly interconnecting these elements. However, in practice multiple branches may connect these elements.

As discussed above, the buffer tank 114 is fluidly attached to a filter 116 and/or degasser 119 that are positioned to filter and degas the ink before the ink reaches the ink reservoir 118. As depicted, the filter 116 and degasser 119 are arranged prior to (i.e., upstream of) fluid traveling through the second ink supply pump 117 and various branches 20. It will be appreciated that the filter 116 and degasser 119 may be positioned at other locations in the conduit, such as after (i.e., downstream of) the second ink supply pump 117. The filter 116 is configured to remove impurities from the ink prior to the ink reaching ink reservoir 118 and the printhead 101. The filter 116 may be a membrane filter, a fibrous filter, a mesh filter, or a different type of appropriate filter for removing impurities. In some embodiments, the degasser 119 may be configured as a membrane that allows air particles to be pulled through while routing the ink towards the ink reservoir 118. The degasser 119 may also remove other dissolved gases or undissolved gases from the ink prior to the ink reaching the printhead 101. As discussed above, the degasser 119 may be a membrane degasser in some embodiments. In other embodiments, the degasser 119 may also be a vacuum degasser, an ultrasonic degasser, or other degasser.

The ink moves fluidly through the ink delivery system 110 through the second ink supply pump 117. The second ink supply pump 117 fills the ink reservoir 118. The top of the volume of ink in reservoir 118 is positioned below the face of the printhead 101, thus applying a negative pressure at the print head nozzles. In some embodiments, one or more of the ink supply pumps (such as second ink supply pump 117) may be a peristaltic pump. Other types of pumps, such as diaphragm pumps, piston pumps, rotary lobe pumps, or a other pump types may be used.

A negative pressure is required to form a meniscus (e.g., a curved surface of liquid ink at the opening of the printhead) in the nozzle, which prevents the nozzles from drooling ink during normal operation. In some embodiments, one or more of the ink supply pumps (such as second ink supply pump 117) may be a peristaltic pump.

In the example configuration shown in FIG. 1, the second ink supply pump 117 is positioned at an elevation that is lower than that of the buffer tank 114. The ink reservoir 118 is positioned at an elevation that is lower than that of the buffer tank 114 and the second ink supply pump 117. With this configuration, gravity helps to pull ink from the buffer tank 114 towards the second ink supply pump 117 and the ink reservoir 118.

The ink reservoir 118 is additionally attached to a purge pump 122. The purge pump 122 allows for pressure to be placed on the ink in the ink reservoir. This pressure causes ink to flow through the printhead, removing contaminants. Additionally, the purge pump 122 may cause initial ink flow from the reservoir 118 to the printhead 101. The printhead 101 includes ink nozzles that through which the printhead 101 ejects droplets of ink. The ink is periodically pushed through the nozzles using the purge pump 122 to clear contaminants or to prepare the nozzles for printing. The purged ink will enter a waste tray 128, from which a pump 126 may draw the waste ink and direct the waste ink to a waste ink reservoir 124.

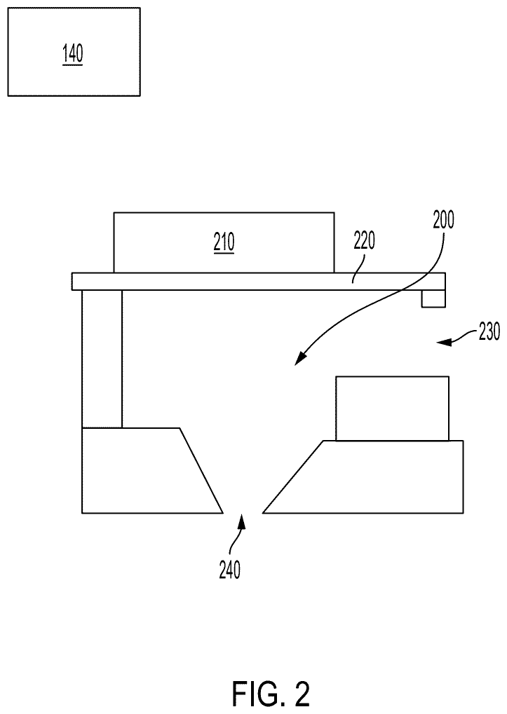

In some configurations, the printhead 101 may be a piezoelectric printhead. Referring to FIG. 2, example elements associated with an ink chamber 200 of such a printhead 101 are shown. The ink chamber 200 includes one or more piezoelectric elements 210 attached to a diaphragm 220. Ink flows into the chamber at an inlet 330 and out of the chamber through a nozzle 240. The piezoelectric element 210 changes shape or size when an electric current is applied to it. During operation, the control system 140 (which also appeared in FIG. 1) causes a voltage to be applied to the piezoelectric material causing the piezoelectric element 210 to deform. Each cycle of the voltage waveform will cause the piezoelectric material to expand and eject the ink, and then contract to immediately refill the chamber. The deformation causes pressure to build on the diaphragm 220 and within the ink chamber 200. This causes ink, in a controlled and precise manner, to be ejected from the nozzle 240 under a controlled pressure.

It will be appreciated that the many print devices employ multiple printheads. For example, a typical printer may include at least three separate printheads.

In summary, the present disclosure relates to methods and systems for addressing ink batch variability in printing systems. As a printer operates over time, it will use multiple batches of ink. Even minor deviations in composition between ink batches can cause substantial variations in printer performance. Minor inconsistencies in ink composition can cause the ink to dry or coagulate within the printhead nozzles. This leads to unacceptable print quality, as even a partial clog in a printhead nozzle can cause the ink to be ejected from the nozzle at an angle that is other than the desired straight line. This can lead to light or dark streaks in images printed by the printhead. In some instances, it can lead to other consequences, all of which require maintenance and/or replacement of the printhead.

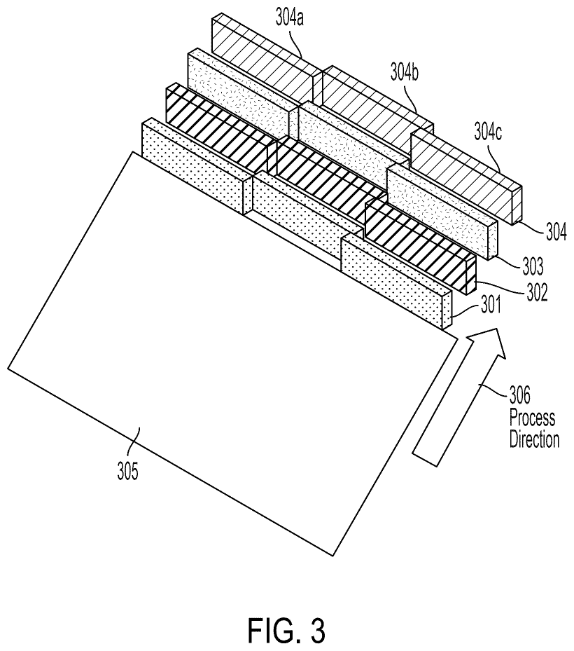

FIG. 3 illustrates in block diagram format that a printer may pass a substrate 305 under four printhead assemblies 301-304, each of which includes multiple printheads that apply ink of various colors to a substrate. For example, in a CMYK color system, printhead assembly 301 may hold and apply black ink (K), printhead assembly 302 may hold and apply cyan ink (C), printhead assembly 303 may hold and apply magenta ink (M), and printhead assembly 304 may hold and apply yellow ink (K). Each printhead assembly will include multiple printheads. In the example shown, each printhead assembly such as printhead assembly 304 includes three printheads 304a, 304b, and 304c. Each printhead of a printhead assembly is oriented to be parallel to the other printheads of the printhead assembly. The printheads of a printhead assembly may be positioned in a row so that the location of an edge of one printhead (such as printhead 304a) matches the location of an edge of its neighboring printhead (such as printhead 304b). Alternatively, the printheads may be positioned so that the edges of neighboring printheads (such as printheads 304a and 304b) overlap with each other in an area that is sometimes referred to as a “stitch zone”. The use of a stitch zone can help to avoid white streaks that may result from each printhead's housing causing separation between the nozzles of neighboring printhead. The configuration of FIG. 3 that of an example printer with multiple printhead assemblies. However, ink batch variability can cause problems not only in printers with multiple printheads, but also in printers that have a single printhead.

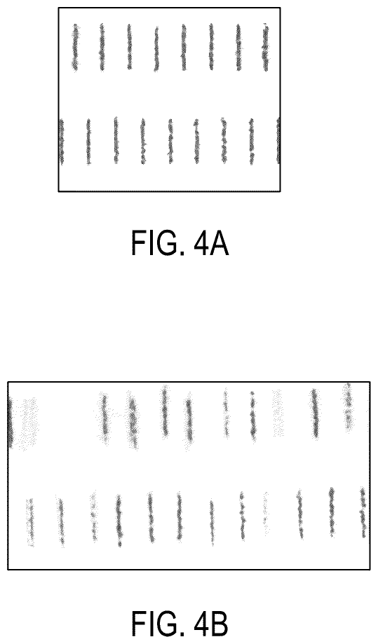

FIG. 4A illustrates an example test pattern of evenly spaced lines generated by a printhead assembly that is not experiencing print quality issues resulting from drop placement degradation due to variability in drop placement. However, FIG. 4B illustrates an example test pattern generated by a printhead assembly in which variations in ink composition are causing the different printheads of the assembly to experience variances in ejected drop direction, as drops from some nozzles are being ejected at an angle other than straight on to the substrate. The test patterns shown in FIGS. 4A and 4B are examples. Other test patterns, such as grids of dots, or other patterns, may be used.

To mitigate the challenges described above, the methods and systems of this disclosure use a prefire operation to prevent the formation of contamination buildup and/or viscous plugs in printhead nozzles that would otherwise be caused by subtle differences in the composition of ink from one batch as compared to that of ink from another batch. In operation, a controller (such as control system 140 in FIG. 1) will generate signals that control the actuators (such as piezoelectric elements 210) of FIG. 2 and nozzles, including fire signals that energize the actuators for a sequence of durations. “Prefiring” refers the use of an electric signal to cause an action in the printhead before the actual firing operation that causes the printhead to print a document. In some aspects of this disclosure, the process modifies the printer's prefire operations based on the particular ink batch that the printer is using, such as by modifying one or more of the printer's default prefire operation setpoints. For example, a default prefire setting may cause electric pulses to be delivered to the piezoelectric elements of the printhead. The modifications may comprise modifying the amplitude, pulse width, rise time, fall time, and/or frequency of the electric pulses to be different from the prefire settings'default values of such parameters. The modification will cause a deliberate perturbation of the ink meniscus that exists in printhead nozzle apertures, and/or agitate (shake and/or stir) the ink within the chambers. The inventors have found that such modifications of the prefire operations can help prevent the formation of viscous plugs, as well as contamination buildup that may result when one or more components of the ink fall out of solution and adhere to the ink delivery hardware in the printhead, all of which can lead to drying and printhead clogs without these modifications.

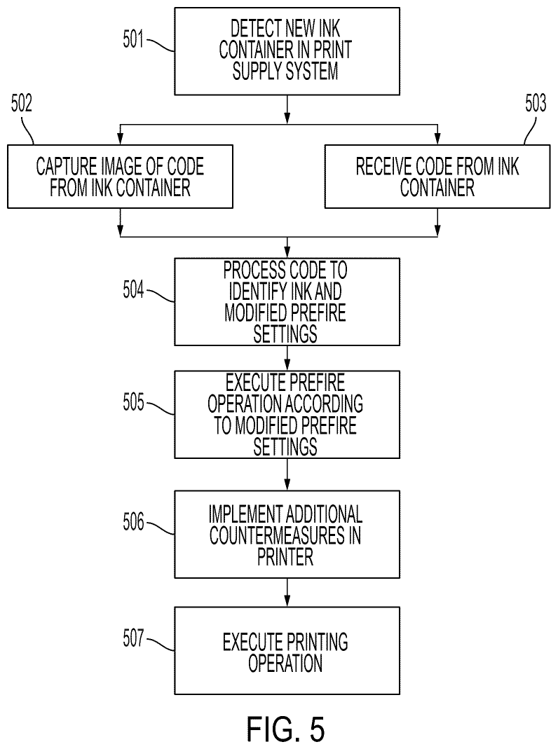

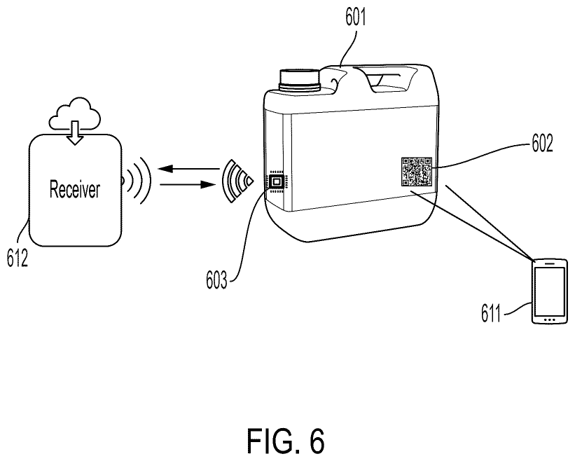

Unlike prior prefire operations, the methods described in this document selectively identify prefire parameters that are based on and associated with the ink batch that is being run through the printhead. FIG. 5 illustrates example steps that such a process may implement. At 503 a processor that is associated with a control system of a print device may receive a code from an ink container that is or will be inserted into the print device. The processor many receive this code in one of several ways. For example, and with reference to both FIGS. 5 and 6:

At 501 a controller of the print device may detect that a new ink container 601, such as an ink cartridge, is or will be inserted into the ink supply system. The system may detect this by one or more sensors returning a signal that an ink container has been removed and replaced, by detecting that an ink container is empty and needs to be replaced, or by receiving a user input, or by other means.

The print device will receive a unique code that is associated with the container. The code can be used to identify the container (and/or the ink batch that is in the container) in later steps. For example, if the print device is equipped with a camera that can capture an image of the ink container, then at 502 the camera may capture an image of an identifying code 602 such as a barcode, serial number, or other code that is attached to the container and associated with the container, and the print device and process the image to extract the code 602 from the image. Alternatively, at 503 the print device may receive the unique code 602 from the container via another input method, such as by receiving the code as input by an operator, or from an electronic device that is equipped with a camera that captured the image of the code. Alternatively, at 502 the print device may output a message that prompts a user to use a camera of an electronic device 611 to capture an image of the code 602 that is attached to the container, and the control system or a scanning application of the electronic device 611 may process the image to extract information from the barcode 602.

If the ink container code is embedded or stored in an electronic device 603 that is affixed to the container, such as a radio frequency identification (RFID) tag, a Bluetooth or near field communication (NFC) transmitter, or other device, then instead of step 502, at 503 a wireless communication receiver 612 of the print device may receive the code as transmitted by the RFID tag, a transmitter, or other device of the device 603 that is attached to the ink container.

After the controller receives the code from the ink container, at 504 the controller will (a) process the code to identify an ink batch from which the ink that the ink supply system receives from the container was sourced, and (b) identify one or more prefire settings that are associated with the ink batch, process the code to obtain an identifier for the ink batch. To do this, the controller may access a data store with data that associates a plurality of prefire settings with a plurality of ink batches and select, from the data store, the prefire settings that are associated with the identifier. The data store may be located in a cloud-based server, on board the print device, or on another that is communicatively connected to the controller. Other methods of associating prefire settings with ink batches may be used, such as by retrieving the prefire settings from the code on the container itself, or by processing the code in a trained machine learning model to return the prefire settings.

At 505 the controller will cause the print device to execute a prefire operation according to the prefire settings. For example, the prefire operation may include applying a set of electrical pulses to one or more of the nozzles in the printhead. The prefire settings may include one or more parameters by which the system will define and generate the pulses, such as amplitude, pulse width, rise time, fall time, and/or frequency. In each case, the parameters will be those that the system determines to be associated with the ink batch of the ink that is in the ink container. Each nozzle includes a tip having an aperture positioned to direct the ink toward the substrate. When the printhead is not being used in a printing operation, a meniscus will form in the ink at the aperture of each nozzle. The electrical pulses will cause the nozzles to vibrate, thus perturb the meniscus (or menisci) in one or more of the nozzles, as well as the chamber(s) within the printhead. This can help reduce or avoid the formation of dry ink or clogs resulting from ink variability.

Optionally, at 506 in addition to executing the prefire operation, the print device may implement one or more additional countermeasures. Example countermeasures include causing the ink supply system to execute a purge operation in the printhead, causing the ink supply system to increase a frequency of purge operations in the printhead, and/or adjusting the vacuum draw in the vacuum platen of the print system. Causing the purge operation execution may include doing so specifically in response to the controller commanding a one-time or repeated execution. Causing the frequency increase may include increasing a frequency of the purge operations that the print device would have otherwise performed. Other countermeasures are possible.

At 507, after executing the prefire operation and (if employed) the additional countermeasures, the print engine of the print device will resume operations and execute a printing operation in which it prints a document according to any suitable printing process.

The following paragraphs provide additional information about various terms used in this document:

In this document, the term “approximately,” when used in connection with a numeric value, is intended to include values that are close to, but not exactly, the number. For example, in various embodiments, the term “approximately” may include values that are within +/−1% of the value, +/−5% of the value, +/−10 percent of the value, or any value or fraction thereof between any or all of the values.

The term “substantially,” when used in connection with a value, is intended to mean approximately, within a threshold tolerance that is a percentage corresponding to any of the percentages described in the previous paragraph. For example, items described as “substantially the same,” “substantially equal,” or “substantially planar,” may be exactly the same, equal, or planar, or may be the same, equal, or planar within acceptable variations that may occur, for example, due to manufacturing processes and/or tolerances.

The terms “printer” and “print device” refer to a machine having hardware capable of reading digital data and using the information from the data and associated print instructions to print a physical document on a substrate. In some embodiments, a print device may have additional capabilities such as scanning or faxing and thus may be a multifunction device. Example print devices include traditional printers and multifunction devices, as well as specialized print devices such as ticket printers, sales receipt printers, and the like. Components of a print device typically include a print engine, as well as a document feeding system configured to pass a substrate through the print device so that the printhead or printheads of the print engine can print characters and/or images on the substrate.

The term “print engine” refers to the marking hardware of a print device, such as a print head, along with marking material storage and delivery components such as a print cartridge containing ink, toner or another marking material. A print engine also includes conveyors, rollers or other media transport components that are configured to move a substrate past the print head to receive printed images onto the substrate. The print engine also may include a control system that controls operation of the hardware described above. In an inkjet printing system, the marking material storage and delivery components may include one or more print heads arranged in a print zone that eject ink drops onto the substrate.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

The terms “processor” and “controller” refer to electronic device hardware that is configured to execute programming instructions. The terms “processor” and “controller” may refer to either a single processor or controllers, or to multiple processors or controllers that together implement various steps of a process. Unless the context specifically states that a single processor is required or that multiple processors or controllers are required, the terms “processor” and “controller” include both the singular and plural embodiments.

The terms “memory,” “memory device,” “computer-readable medium” and “data store” each refer to a non-transitory device on which computer-readable data, programming instructions or both are stored. Unless the context specifically states that a single device is required or that multiple devices are required, the terms “memory,” “memory device” “computer-readable medium” and “data store” include both the singular and plural embodiments, as well as portions of such devices such as memory sectors.

This disclosure is not limited to the particular systems, methodologies or protocols described, as these may vary. The terminology used in this description is for the purpose of describing the particular versions or embodiments only and is not intended to limit the scope.

It will be understood that various modifications may be made to the embodiments disclosed in this document. Likewise, the above disclosed methods may be performed according to an alternate sequence. Therefore, the above description should not be construed as limiting, but merely as examples of the various embodiments. Those skilled in the art will envision other modifications within the scope and spirit of the claims appended to this document.

Without excluding additional embodiments, certain example embodiments are summarized in the following clauses:
Clause 1: A print system includes: (a) an ink supply system comprising an ink reservoir configured to receive ink from an ink container and hold the ink for use in a printing operation; (b) a printhead that is fluidly connected to the ink supply system to receive the ink from the ink supply system; and (c) a control system comprising a processor and programming instructions. The programming instructions are configured to cause the processor to, in response to receiving a code that is associated with the ink container: process the code to identify an ink batch from which the ink that the ink supply system receives from the container was sourced; identify one or more prefire settings that are associated with the ink batch; and cause the printhead to execute a prefire operation according to the one or more prefire settings.
Clause 2: The system of clause 1, wherein the printhead comprises a plurality of nozzles, and the prefire operation comprises applying a set of electrical pulses to one or more of the nozzles in the printhead.
Clause 3: The system of clause 2, wherein the set of electrical pulses comprises a plurality of pulses having an amplitude, pulse width, rise time, fall time, and/or frequency that corresponds to the ink batch.
Clause 4: The system of clause 2, wherein: each nozzle comprises a tip having an aperture positioned to direct the ink toward a substrate; when the printhead is not being used in a printing operation, a meniscus will form in the ink at the aperture of each nozzle; and the set of electrical pulses will vibrate the nozzles, which will agitate the ink and/or perturb the meniscus in one or more of the nozzles.
Clause 5: The system of any of clauses 1-4, wherein the instructions to process the code to identify the ink batch and identify one or more prefire settings that are associated with the ink batch comprise instructions to: (a) process the code to obtain an identifier for the ink batch; (b) access a data store with data that associates a plurality of prefire settings with a plurality of ink batches; and (c) select, from the data store, the prefire settings that are associated with the identifier.
Clause 6: The system of any of clauses 1-5, further comprising a camera, an wherein the control system is further programmed to (a) receive an image of the ink container captured by the camera, and (b) process the image to extract the code from a barcode that is affixed to the container.
Clause 7: The system of any of clauses 1-5, further comprising a wireless receiver, and wherein the control system is further programmed to receive a signal from a transmitter that is attached to the ink container and process the signal to extract the code from the signal.
Clause 8: The system of any of clauses 1-7, wherein the control system is further programmed to: (a) in response to detecting that the ink container is or will be inserted into the ink supply system, output a prompt to prompt a user of the print system to capture an image of a barcode on the ink container; and (b) in response to receiving data comprising an image of the code or information contained in the code, process the image to extract the code or the information from the image.
Clause 9: The system of any of clauses 1-8, wherein the control system is further programmed to, in response to receiving the code that is associated with the ink container, execute one or more additional countermeasures that comprise: (a) causing the ink supply system to execute a purge operation in the printhead; (b) causing the ink supply system to increase a frequency of purge operations in the printhead; and/or (c) adjusting vacuum draw in a vacuum platen of the print system.
Clause 10: The system of any of clauses 1-9, wherein elements of the processor that perform processing the code to identify the ink batch and identifying the one or more prefire settings that correspond to the ink batch are included onboard the print system.
Clause 11: The system of any of clauses 1-10, wherein elements of the processor that perform processing the code to identify the ink batch and identifying the one or more prefire settings that correspond to the ink batch are outside of the print device and are communicatively connected to the print system.
Clause 12: A method of addressing variations in ink batches is implemented in a print device that comprises an ink supply system, a printhead that is fluidly connected to the ink supply system, and a control system comprising a processor. In the method, in response to receiving a code that is associated with an ink container that is installed in the ink supply system, the control system may (i) process the code to identify an ink batch from which the ink that the ink supply system receives from the container was sourced, (ii) identify one or more prefire settings that are associated with the ink batch, and (iii) cause the printhead to execute a prefire operation according to the one or more prefire settings.
Clause 13: The method of clause 12, wherein causing the printhead to execute the prefire operation comprises causing the printhead to modify one or more parameters of a set of electrical pulses that are applied to one or more nozzles in the printhead during a default prefire operation.
Clause 14: The method of clause 13, wherein the one or more parameters comprise an amplitude, pulse width, rise time, fall time, and/or frequency of the electrical pulses.
Clause 15: The method of any of clauses 12-14, wherein processing the code to identify the ink batch and identify one or more prefire settings that are associated with the ink batch comprises: (a) processing the code to obtain an identifier for the ink batch; (b) accessing a data store with data that associates a plurality of prefire settings with a plurality of ink batches; and (c) selecting, from the data store, the prefire settings that are associated with the identifier.
Clause 16: The method of any of clauses 12-15, wherein receiving the code and processing the code comprises: (a) receiving, from a camera, an image of the ink container; and (b) processing the image to extract the code from a barcode that is affixed to the ink container.
Clause 17: The method of any of clauses 12-15, wherein receiving the code and processing the code comprises: (a) receiving a signal from a transmitter that is attached to the ink container; and (b) processing the signal to extract the code from the signal.
Clause 18: The method of any of clauses 12-17, further comprising: (a) in response to detecting that the ink container is or will be inserted into the ink supply system, outputting a prompt to prompt a user of the print system to capture an image of a code on the ink container; and (b) in response to receiving data comprising an image of a code or information contained in the code, processing the image to extract the code or the information from the image.
Clause 19: The method of any of clauses 12-18 further comprising, by the control system in response to receiving the code, executing one or more additional countermeasures that comprise: (a) causing the ink supply system to execute a purge operation in the printhead; (b) causing the ink supply system to increase a frequency of purge operations in the printhead; and/or (c) adjusting vacuum draw in a vacuum platen of the print device.
Clause 20: The method of any of clauses 12-19, wherein elements of the control system that perform processing the code to identify the ink batch and identifying the one or more prefire settings that correspond to the ink batch are outside of the print device and are communicatively connected to the print system.
Clause 21: A computer program product comprising a memory device containing programming instructions that are configured to cause a processor to implement a method according to any of clauses 12-20.

1. A print system, comprising:
an ink supply system comprising an ink reservoir configured to receive ink from an ink container and hold the ink for use in a printing operation;
a printhead that is fluidly connected to the ink supply system to receive the ink from the ink supply system; and
a control system comprising a processor and programming instructions that are configured to cause the processor to, in response to receiving a code that is associated with the ink container:
process the code to identify an ink batch from which the ink that the ink supply system receives from the container was sourced,
identify one or more prefire settings that are associated with the ink batch, and
cause the printhead to execute a prefire operation according to the one or more prefire settings.

2. The system of claim 1, wherein:
the printhead comprises a plurality of nozzles; and
the prefire operation comprises applying a set of electrical pulses to one or more of the nozzles in the printhead.

3. The system of claim 2, wherein the set of electrical pulses comprises a plurality of pulses having an amplitude, pulse width, rise time, fall time, and/or frequency that corresponds to the ink batch.

4. The system of claim 2, wherein:
each nozzle comprises a tip having an aperture positioned to direct the ink toward a substrate;
when the printhead is not being used in a printing operation, a meniscus will form in the ink at the aperture of each nozzle; and
the set of electrical pulses will vibrate the nozzles, which will agitate the ink and/or perturb the meniscus in one or more of the nozzles.

5. The system of claim 1, wherein the instructions to process the code to identify the ink batch and identify one or more prefire settings that are associated with the ink batch comprise instructions to:
process the code to obtain an identifier for the ink batch;
access a data store with data that associates a plurality of prefire settings with a plurality of ink batches; and
select, from the data store, the prefire settings that are associated with the identifier.

6. The system of claim 1, further comprising:
a camera; and
wherein the control system is further programmed to:
receive an image of the ink container captured by the camera, and
process the image to extract the code from a barcode that is affixed to the container.

7. The system of claim 1, further comprising:
a wireless receiver; and
wherein the control system is further programmed to receive a signal from a transmitter that is attached to the ink container and process the signal to extract the code from the signal.

8. The system of claim 1, wherein the control system is further programmed to:
in response to detecting that the ink container is or will be inserted into the ink supply system, output a prompt to prompt a user of the print system to capture an image of a barcode on the ink container; and
in response to receiving data comprising an image of the code or information contained in the code, process the image to extract the code or the information from the image.

9. The system of claim 1, wherein the control system is further programmed to, in response to receiving the code that is associated with the ink container, execute one or more additional countermeasures that comprise:
causing the ink supply system to execute a purge operation in the printhead;
causing the ink supply system to increase a frequency of purge operations in the printhead; and/or
adjusting vacuum draw in a vacuum platen of the print system.

10. The system of claim 1, wherein elements of the processor that perform processing the code to identify the ink batch and identifying the one or more prefire settings that correspond to the ink batch are included onboard the print system.

11. The system of claim 1, wherein elements of the processor that perform processing the code to identify the ink batch and identifying the one or more prefire settings that correspond to the ink batch are outside of the print device and are communicatively connected to the print system.

12. A method of addressing variations in ink batches, the method comprising, in a print device that comprises an ink supply system, a printhead that is fluidly connected to the ink supply system, and a control system comprising a processor:
in response to receiving a code that is associated with an ink container that is installed in the ink supply system:
processing the code to identify an ink batch from which the ink that the ink supply system receives from the container was sourced,
identifying one or more prefire settings that are associated with the ink batch,
and
causing the printhead to execute a prefire operation according to the one or more prefire settings.

13. The method of claim 12, wherein causing the printhead to execute the prefire operation comprises causing the printhead to modify one or more parameters of a set of electrical pulses that are applied to one or more nozzles in the printhead during a default prefire operation.

14. The method of claim 13, wherein the one or more parameters comprise an amplitude, pulse width, rise time, fall time, and/or frequency of the electrical pulses.

15. The method of claim 12, wherein processing the code to identify the ink batch and identify one or more prefire settings that are associated with the ink batch comprises:
processing the code to obtain an identifier for the ink batch;
accessing a data store with data that associates a plurality of prefire settings with a plurality of ink batches; and
selecting, from the data store, the prefire settings that are associated with the identifier.

16. The method of claim 12, wherein receiving the code and processing the code comprises:
receiving, from a camera, an image of the ink container; and
processing the image to extract the code from a barcode that is affixed to the ink container.

17. The method of claim 12, wherein receiving the code and processing the code comprises:
receiving a signal from a transmitter that is attached to the ink container; and
processing the signal to extract the code from the signal.

18. The method of claim 12, further comprising:
in response to detecting that the ink container is or will be inserted into the ink supply system, outputting a prompt to prompt a user of the print system to capture an image of a code on the ink container; and
in response to receiving data comprising an image of a code or information contained in the code, processing the image to extract the code or the information from the image.

19. The method of claim 12 further comprising, by the control system in response to receiving the code, executing one or more additional countermeasures that comprise:
causing the ink supply system to execute a purge operation in the printhead;
causing the ink supply system to increase a frequency of purge operations in the printhead; and/or
adjusting vacuum draw in a vacuum platen of the print device.

20. The method of claim 12, wherein elements of the control system that perform the steps of processing the code to identify the ink batch and identifying the one or more prefire settings that correspond to the ink batch are outside of the print device and are communicatively connected to the print device.
